(19) United States
(12) Patent Application Publication
(10) Pub. No.: US 2003/0219709 A1
(43) Pub. Date: Nov. 27, 2003

(54) System and method for educating, managing, and evaluating clients of professionals

(76) Inventors: Mollee Olenick, Irvine, CA (US); Michael Olenick, Irvine, CA (US)

Correspondence Address: OPPENHEIMER WOLFF & DONNELLY LLP, 840 NEWPORT CENTER DRIVE, SUITE 700, NEWPORT BEACH, CA, 92660, US

(21) Appl. No.: 10/155,719

(22) Filed: May 24, 2002

(51) Int. Cl. G09B 3/00

(52) U.S. Cl. 434/350; 434/219; 434/322; 434/362

(57) ABSTRACT

A networked-based learning system wherein healthcare providers, or other professionals, establish business rule chains encompassing a series of business rule events and apply a chain to a specific client. The chains include a series of lessons and feedback mechanisms, usually tied to a specific chronological event. At the appropriate time the client's dossier is combined with specific business rules to dynamically generate a specific lesson, as well as an optional feedback loop. This lesson is then communicated to the client either electronically by any electronic method including but not limited to email, web page, SMS message, and voice or via tangible media including but not limited to postal mail, fax, or courier. After completing their lesson the patient moves through a feedback mechanism assessing how well they learned the material; this feedback loop is transferred back to the professional either electronically or via tangible media.

### BACKGROUND OF THE INVENTION

1. Field of the Invention

The present invention relates generally to education of clients of professionals. More particularly it describes a system and method for creating a series of individualized lessons that are administered, usually via email, to clients at periodic times and/or events then feeding back information to the professional about a client's grasp of the material. Finally, it also contains a provision allowing for pre-payment of professional fees as an integrated component to a remote client teaching device and method.

2. General Background and State of the Art

The information age has caused the complexity of both science and law to greatly escalate in recent years. Whereas an obstetrician might have once been comfortable asking a pregnant woman how she felt each month and advising her to eat well, that same doctor must now check for thousands of potential complications and decide whether to order any of a magnitude of tests. Similarly whereas an accountant might have once told his client to gather and sort receipts, that same professional now must sort through a myriad of potential decision tree junctures. A patent lawyer who once focused almost solely on tangible inventions must not prepare her client to address method patents, system patents, and sort through an ever growing pool of material.

In an effort to alleviate some confusion technologists have for years been trying to create expert systems. Sometimes these systems enjoy moderate success, though most have been failures. There exists a basic paradox wherein computers have allowed the creation of a mountain of information, yet only humans are smart enough to sort and understand that information.

This invention leverages the mechanisms that have caused the information explosion—computers and networks—and fuses them together with the only effective expert system in existence: human beings.

Computers have been sending lessons to people for a long time, and continue to do so. Further, both the senders and recipients of computerized messages do receive limited benefits from the systems currently in place. However, this invention substantially increases those benefits by allowing for the creation of and automating the dispatch process for substantially more highly customized messages.

Prior systems may be divided into several categories:

Systems that send non-targeted communications

Systems that send targeted communications to large groups

Systems that send minimally customized information

Systems that send minimally customized information at preset times

Systems that send personalized and customized information at appropriate times, but do not customize the information in a manner to train the recipient to be more receptive and productive at an upcoming meeting with a professional

There exists a myriad number of information providers who publish information that is either partially or completely divorced from the daily realities of their consumers. For example, a healthcare website might send weekly newsletters detailing general fetal development that do not at all take into account the specific health of a patient which might materially affect what behaviors she should engage in, or that overlook complications one patient may be more vulnerable to than others.

However, none of these systems—as their core purpose—creates customized and personalized messages targeted towards the clients of professionals aimed at lever-aging the educated client in an effort to provide better services.

Even if such a system did exist there does not exist an adequate feedback mechanism to extend visibility to professionals, showing them exactly how much of the material their clients understand. Without the ability for the professional to know how much of the information their client understood a prudent professional must spend time reiterating the same information sent before the appointment between the professional and the client, a waste of time for both of them.

Note that there are business rule systems that use email for cross-computer communication. For example, an end-user sends an email to a server which parses the email and tries to do something intelligent with it (like preparing a quotation or searching for applicable articles through the world-wide-web). This invention is substantially different because it does not rely on incoming messages from clients, nor does it try to parse plain-language text, nor does it interface with computers as it's final objective (it interfaces with people). The purpose of this system is to educate clients, who then become experts—enabling clients to identify applicable knowledge elements—rather than have a computer do the intelligent work.

This invention is unique. Note that while business rules and the business rule engine are cited and important, they are only a component of this system. That is because business rules and business rule engines are not new: they are decades old. This system leverages business rules and a business rules engine, along with other components cited above, to create an entirely new application.

### INVENTION SUMMARY

One embodiment of the present invention allows professionals to establish business rules which are then used to dynamically create contextually meaningful lessons tailored to clients of the professional. The system renders and sends these lessons in a timely manner to the clients. It tests these recipients to discern how well they absorbed the material. Finally, it forwards a report detailing the recipients understanding to the professional.

The present invention describes a system and a method to educate clients of a professional at the time such education is necessary—about procedures, conditions, events, and/or warning signs which the client should be aware.

For example, an obstetrician might put a woman expecting a child on a standard schedule, requiring her to visit monthly until the last month of her pregnancy, at which time she would visit weekly. This invention would fuse together business rules set up by her doctor with her personal dossier in an effort to send her customized lessons. These lessons would answer questions she might have about her upcoming appointment, in an effort to both shorten that visit and increase the quality of the visit. To ascertain how much of the information the patient understood, the message may optionally contain a quiz at the end of it. The system may be configured to forward the patient's answers to the professional for use in deciding how best to use her/his time during the upcoming visit.

Considering some additional hypothetical professional/client situation, in the case of a young mother, the reports might emphasize the need to eat well and get a lot of rest. An overweight mom would be repeatedly warned about the risks associated with obesity and pregnancy. African American mothers might be warned about the risks of Sickle Cell anemia, and told about tests available. Jewish mothers may receive warnings about Tai-Sachs. After receiving their messages these women may optionally be asked to take a quiz to show their healthcare provider how well they read the material; those that read it carefully may not, for example, need to have the information repeated at their office visit.

Similarly, in the context of a lawyer/client relationship, a lawyer might be able to send objective information that can be read in the privacy and comfort of one's own home. For example, in family law matters the lawyer could send informational packets about what to expect at an upcoming meeting or hearing, allowing their client to work through the emotional aspects of the material at their own pace. Accountants, too, might find the information useful, combining an individual or corporation's computer records with business rules to help the individual fully prepare for an upcoming event.

Embodiments of the present invention may facilitate higher quality client visits to the professional. Because the professional need not repeatedly answer the same questions—knowing definitively that their client has already received answers to those questions—the professional may be able to spend more time discussing meaningful issues, and spend less time asking general screening questions.

By receiving customized education, the client may be more likely to provide focused information without being prodded, leading to a better outcome. For example, a doctor might send articles and quizzes about the risks of miscarriage in the case of certain behaviors. If the patient chose to participate in those behaviors—for example, smoking—they might notice warning signs and call their healthcare provider earlier, possibly diverting an undesirable outcome.

Another advantage is that the professional, via the feedback mechanism, is able to better collect better records about their client allowing them to better understand their individual client's needs without spending additional time asking repetitive, routine interviews.

Another advantage is that the system may be used to automate certain clerical or semi-clerical tasks. For example, a method to collect insurance information, collect background information, enable payments, or query their client's preferences may be integrated into the feedback mechanism. When these tasks are automated, these routine tasks either require less support staff or free support staff to do more interesting things.

Providers may take advantage of a customization feature to warn about material changes, not only to their client's condition but also their insurance data, when applicable. For example, a change in the terms of an insurance policy would be relayed from the computers of the insurance company to a computer running this system or using this method. This would be an event, setting off a chain of business rules or being integrated into another event—for example, an upcoming visit—reminding the client to bring in their new insurance card.

By methodically ensuring that their clients are informed about procedures and/or risks, professionals might mitigate their liability in any ongoing negligence claims. In certain embodiments of the invention, the client may take a quiz or provide other feedback to verify that the client has understood the information that the professional has provided. In particular embodiments, the system may require the client to pass a quiz in order to proceed onto some event, such as scheduling a next appointment. Similarly, the professional may give the client a discount on services or another type of bonus when the client successfully passes a quiz about information provided to the client.

To certain providers—especially high risk specialties including and especially focusing on obstetrics—an audit trail that their patients were informed of all risks, understood those risks, understood the alternatives, and chose to assume the risk anyway could greatly help to either disprove negligence, prove assumption of the risk, or help to mitigate damages.

Considering further optional aspects, professionals may create individual Business Rule Events (“BRE's”) or BRE chains which they may then market to other professionals. These chains may reflect professional preferences. For example, in certain European countries it is common to deliver babies at home. However, in other countries it is common to deliver babies in hospitals or birthing centers. An entrepreneurial European doctor may create a series of BRE's that reflect the customs and laws of her country and license this set to another provider, who may wish to use it verbatim or modify it. This business model benefits professionals in that it gives BRE/BRE chain providers a new source of income. It gives those who purchase customized BRE/BRE chains a client educational experience closer to their personal preferences.

Another advantage is that insurers may either insist that certain BRE/BRE chains are included or may provide discounts if certain BRE/BRE chains are provided. These chains may outline certain “best practices” in the eyes of the insurer, may lead to a series of steps to disclaim or mitigate liability, or may help provide an early warning or audit function to potentially problematic clients.

Further embodiments of the invention, as well as optional features, details and/or alternatives, are shown in the drawings, the Brief Description and the Claims.

### BRIEF DESCRIPTION OF THE DRAWINGS

FIG. 1 is a block diagram describing the master workflow that may happen when a professional accepts either a new client or moves a client into a new business rule chain;

FIG. 2 is a block diagram describing the different methods a professional may choose when attaching a specific client to a business rule chain or chains.

FIG. 3 is a block diagram explaining the steps the system takes when it is time to construct and send a specific message.

FIG. 4 is a block diagram relating to an optional payment feature;

FIG. 5 is a block diagram illustrating BRE and BRE chain construction;

FIG. 6 is a block diagram illustrating BRE and BRE chain attachment;

FIG. 7 is a block diagram illustrating BRE and BRE chain client interaction; and

FIG. 8 is a block diagram illustrating one specific embodiment of a communication from the professional to a client of the professional.

### DETAILED DESCRIPTION OF THE PREFERRED EMBODIMENTS

The present invention relates to a method and system that allows professionals to dynamically create highly personalized informational communications for their clients, efficiently deliver these communications to their client, receive a receipt confirming their client received the communication, then receive feedback quantifying how much of the data their client was able to digest.

For example, a psychotherapist with a new client, who is a 50 year-old woman might do the following. First, the therapist might attach the new client first to an “intake” chain. Later, after the therapist has been able to diagnose her patient, she might attach her to a “depression” chain. However, on top of the depression chain she might also attach a chain that applies to women and a chain that applies to people in her age group. When these chains are laid over the patients schedule the patient is sent contextually applicable appointment preparatory work and the results of that work are later sent back to the professional.

One embodiment of this system is a classic client server configuration. In this configuration a single computer or coordinated cluster of computers work together to run one or more computer programs that, collectively, implement the functionality described herein.

The server—a centralized general purpose computer linked to a network—contains the computer program described in this system. A typical server includes one or more computing devices containing the standard hardware found on a typical modern computing device: one or more logical processing devices (currently referred to as CPU's), one or more storage devices (currently disk drives though any fast, general purpose storage device is suitable), and a series of volatile memory banks, helper chips, and busses to tie the devices together. Server software usually includes an operating system, database, and application server though these components are not strictly necessary for the invention described herein.

This server is connected to one or more client computers via a network. A typical network is a series of computing devices tied together via a shared, common protocol. For example, the Internet is a large computer network tied together by a series of computers that agree to use the TCP/IP network communication and routing protocol. However, a network need not necessarily use TCP/IP: for purposes of this invention a network is described as any collection of computer devices that inter-communicate either synchronously or asynchronously.

The client computers may be classic general-purpose computing devices, specialized communication devices, or specialized embedded devices. For example, a client computer may be a general-purpose computing device with an input mechanism (usually a keyboard), screen, disks, processor, and power source. However, for the invention described herein, alternative client computers are envisioned and incorporated. These may include telephones that are capable of sending and receiving messages (“SMS”), telephones that send and receive pictures, and video, tablet computers that rely on a CPU and disk mechanism not physically inside the computer box, ePaper powered by a computer somewhere else and tied to that computer by either wires or wireless radio frequencies, screens with or without attached processing units embedded in cars and household appliances, and general-purpose public computer kiosks. By using open standards for communication and programming via a Model-View-Controller (MVC) the invention described herein is scaleable to any of these devices.

The core of one embodiment of the system is a method for storing business rule events (BRE's). Each BRE may eventually be used by the system to create or append a message. Each BRE may contain a combination of text, graphics, photographs, video, animations, or other multimedia content. Additionally each BRE may contain a series of business rules that make the content useful. Next each BRE may contain a priority value, showing how its content is prioritized with other BRE's when more than one BRE is applicable. Finally, a BRE may optionally contain a quiz that assesses the extent that the recipient of the dynamically rendered BRE understood and absorbed the material.

A sample BRE might contain information commonly used when entering a third month of pregnancy; verbiage describing what to expect at one's 3-month checkup, a link to (or embedded video of) an ultrasound (that is typically performed at a 3-month checkup), some common symptoms to be aware of and what to do should they occur, recommended exercises and foods, and/or hypertext links pointing to bulletin-boards and chats of others expecting in the same month. The business rule component of this BRE would show it applies to women who are scheduled the day after for a three-month checkup. A second business rule might specify to check other BRE's for “add-on” information. This rule would force the scanning of a secondary set of BRE's where a BRE applicable to women going to a three-month checkup who are overweight also contain additional information. The information from this secondary BRE is appended to the first BRE. A third BRE containing information for pregnant women who are over 35 years old might also be appended. Finally, our original BRE would contain a base quiz, appended by the quizzes in the subsequent BRE's.

After a BRE “fires”—that is, an embedded business rule engine determines that the events within the BRE have all been met, the BRE invokes the BRE rendering engine. This engine culls the information from the core BRE, and any additional sub-BRE's, and renders the communication that is to be sent. This BRE rendering mechanism may either reside on the central server and use a helper mail server, or—for higher efficiency—reside directly inside the recipient's mail server. The BRE rendering mechanism renders the BRE(s) into one coherent message, personalized and customized to the client they are intended to, and sends the communication along. Note that business rule engines in general are not a new invention and are well known in the art.

Using specific examples, assume we have a pregnant women whose doctor has attached her to both the standard pregnancy BRE chain as well as an additional complications chain. One of the BRE's in the standard chain might be programmed by the doctor to “fire”—that is, to become true—one day before the patient's four month checkup. Additionally, in the secondary complications chain another BRE fires when it's two conditions are met. One of these conditions is that any appointment is upcoming, and the second is that the patient is more than 20-percent overweight. Assume the primary BRE has a priority of three (that is, the highest) while the second BRE has a priority of three (that is, lower). The information from the second BRE would be combined by the rendering engine into the information—including the quiz—from the first BRE and the entire lesson would be forwarded to the patient.

BRE's are grouped into logical segments. These segments are called BRE “chains”. BRE chains may or not be sequential. Each BRE chain envelopes one segment the professional is concerned with. For example, a BRE chain may envelop and surround a typical pregnancy. This BRE chain might be called “Typical MD-sponsored US pregnancy”. A secondary BRE chain may envelop complications typically associated with a pregnancy. This secondary chain might be called “MD-sponsored pregnancy complications”. A third BRE chain might be used by US nurse-midwives. This chain, unlike the MD chain, might suggest slightly different procedures, articles, and/or preferences. A provider would choose to use either the MD-sponsored chain or the nurse-midwife chain, but both might decide to lay the typical complications chain on top.

Chains may be as small as one BRE or as large as thousands of BRE's. Chains may be sold or given away. Additionally, insurers, government agencies, professional organizations, or any other interested entity may either insist or provide an incentive for a professional to overlay a liability/disclosure chain.

Once a professional accepts a new client they choose which BRE chain or chains are applicable to that client. They then have the choice to override a specific BRE, BRE chain, or add an additional BRE or BRE chain. Additionally, one embodiment of the present invention involves automatically cross-referencing a client profile to select an appropriate BRE chain.

After a specific client is tied to a BRE chain the BRE rendering mechanism broadcasts messages when appropriate. The messages are rendered versions of one or more BRE's, as described above. BRE's are transformed by the BRE rendering mechanism into page description languages that may be read by various client computers. These page rendering languages—well known in the art—include but are not limited to Hypertext Markup Language (HTML), Extensible Markup Language (XML), plain text, rich text, Cascading Style-sheets (CSS), Wireless Markup Language (WML), SMS message, and any other similar page description language.

Clients of the professionals receive these communications on their own client computers. These computers—a list of which is enumerated above—transform the rendering language created by the BRE rendering mechanism into a representation suitable for the specific output device supported by the individual client computer. Depending upon the specific functionality of the specific message transport used a verification of transmission and/or deliver is returned to the server. Verifications of transmission are always sent. Verification of receipt—via a number of methods known within the art and not within the scope of this invention—is also sent whenever possible.

Once a client receives a message they may digest and react to it at their own leisure. This is an important advantage over the prior art, which often involved presenting the client information while at the professional's office. By delivering content to the client away from the office of the professional the client may be more receptive, may repeatedly review the information until they feel they understand it, may spend more time reviewing the information, may emotionally react to the content in their own area, and might take time to interact with others about the content.

Sometime after they receive the communication but before they arrive for their visit with the professional the client will take a test embedded into the communication. This test—rendered from the core BRE's at the same time the message was rendered—is designed to test the client's understanding of the material. The results of the BRE quiz are returned to the professional immediately upon completion by the client and may be viewed at any time either via a series of screens provided by this invention for just this purpose or via cooperative computer systems by inter-computer communications methods known within the art and including Remote Method Invocation (RMI), Web Services, and other similar inter-computer protocols.

Note that it is entirely possible that the return of a BRE quiz may satisfy the conditions of a separate BRE, restarting the process. For example, a BRE sent by an accountant may contain a quiz item querying if the client sold real-estate. Answering yes could conceivably trigger a BRE that focuses specifically on real-estate transactions, educating the client about the financial and tax implications so the client and professional may have a more meaningful dialog on this subject during the upcoming visit than they would otherwise have been likely.

Assuming the BRE is finished and the cycle complete the BRE recipient eventually meets with the BRE sender for their session. At this point the professional who created and sent the BRE will have a dashboard overview of how well the client they are meeting with understood the information. Based upon both the knowledge taught to their client as well as the feedback they received they will hopefully have a more productive, possibly shorter, and likely more fulfilling session. The reason is that the client—assuming the BRE was well prepared and the client read it—will have been educated about the purpose of their visit. The client should be able to function as a biological value-added expert system, providing information to the professional they might not have known was germane had the prepared lesson not been sent.

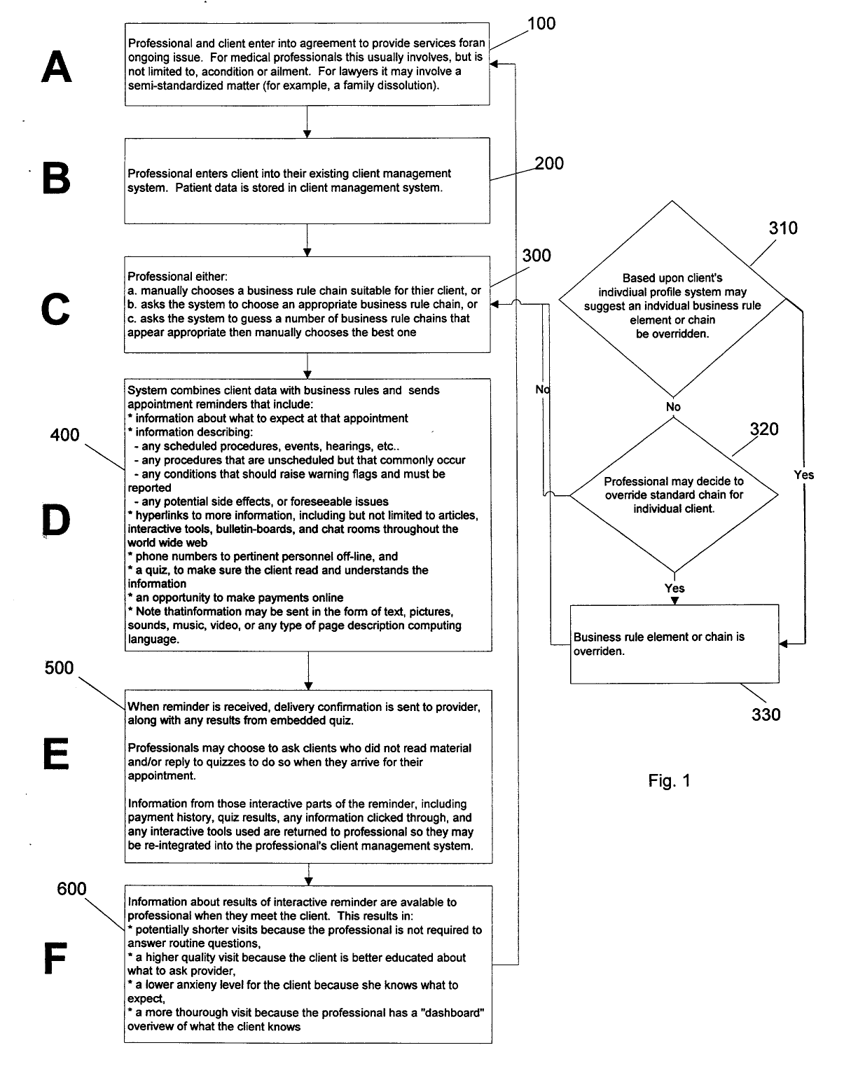

Considering particular embodiments of the invention, in which a particular embodiment may include one or more of the features that this Detailed Description describes, in step 100 (FIG. 1), a professional and client enter into agreement under which the professional provides services. For medical professionals this usually involves, but is not limited to, treatment for a condition or ailment. For lawyers it may involve a semi-standardized matter (for example, a family dissolution), preparation of a patent application, a lawsuit, or any of the myriad matters that attorneys handle.

At step 200, the professional enters client information into a client management system, in which patient data is stored. The client management system may be, for example, a standard client management system that the professional typically uses. Additional software may be provided to perform various steps in the method. The software may, for example, be adapted to interface with the existing professional client management system. Alternatively, steps of the method may be implemented with a pre-integrated system., rather than with an add-on system that interfaces with an existing professional client management system.

At step 300, the professional may:

a. manually choose a business rule chain suitable for their client, or

b. ask the system to choose an appropriate business rule chain, or

c. ask the system to guess a number of business rule chains that appear appropriate, then manually choose the best one

At step 310, based upon a client's individual profile, the system may suggest that an individual business rule element or chain be overridden. Alternatively, at step 320 the professional may decide to override the standard chain for an individual client. Either way, at step 330, the business rule element or chain is overridden.

At step 400, the system combines client data with business rules and sends communications to the client, which may include appointment reminders. The appointment reminders may include such information as

information about what to expect at that appointment

information describing:

any scheduled procedures, events, hearings, etc.

any procedures that are unscheduled but that commonly occur

any conditions that should raise warning flags and must be reported

any potential side effects, or foreseeable issues

hyperlinks to more information, including but not limited to articles, interactive tools, bulletin-boards, and chat rooms throughout the world wide web

phone numbers to pertinent personnel off-line, and

a quiz, to make sure the client read and understands the information

an opportunity to make payments online.

Note that this information may be sent in any of a variety of different formats such as, for example, text, pictures, sounds, music, video, or any type of page description computing language.

In step 500, when the client receives the information, a delivery confirmation may be sent to the provider, along with optional additional information, such as results from an optional quiz that is embedded in the information originally sent to the user. Based on the information that the professional receives back from the client, the Professional may choose to ask clients who did not read material and/or reply to quizzes to do so when they arrive for their appointment.

Information from interactive parts of the reminder, such as payment history, quiz results, any information clicked through, and any interactive tools used, may be returned to professional so they may be re-integrated into the professional's client management system.

At step 600, information about results of interactive reminder may be available to the professional when meeting with the client. Advantages of embodiments of this system may include potentially shorter visits because the professional is not required to answer routine questions, a higher quality visit because the client is better educated about what to ask provider, a lower anxiety level for the client because she knows what to expect, a more thorough visit because the professional has a “dashboard” overview of what the client knows.

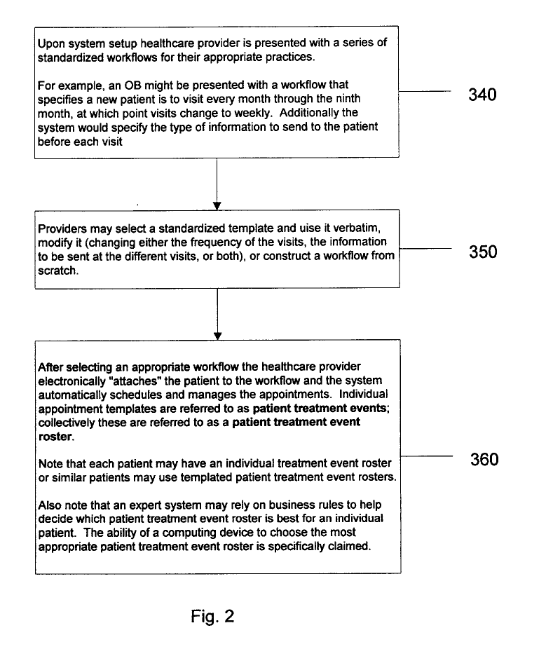

Returning to step 300, FIG. 2 illustrates one possible manner in which a healthcare provider, for example, setup one system. In the specific example of FIG. 2, upon system setup the healthcare provider is presented with a series of standardized workflows for their appropriate practices, at step 340.

For example, an OB might be presented with a workflow that specifies a new patient is to visit every month through the ninth month, at which point visits change to weekly. Additionally the system would specify the type of information to send to the patient before each visit.

At step 350, providers may select a standardized template and use it verbatim, modify it (changing either the frequency of the visits, the information to be sent at the different visits, or both), or construct a workflow from scratch.

At step 360, After selecting an appropriate workflow the healthcare provider electronically “attaches” the patient to the workflow and the system automatically schedules and manages the appointments. Individual appointment templates are referred to as patient treatment events; collectively these are referred to as a patient treatment event roster.

It may be noted that each patient may have an individual treatment event roster or similar patients may use templated patient treatment event rosters. Also note that an expert system may rely on business rules to help decide which patient treatment event roster is best for an individual patient. The ability of a computing device to choose the most appropriate patient treatment event roster is specifically claimed.

One advantage of one embodiment of the system is that if a client is fully informed about his or her current situation before their visit to the professional, their visit may be shorter. In the case of hourly fees, this saves the client expense. In the case of most medical providers—who are paid by the visit regardless of length—it may save the provider expense by allowing them to see more patients.

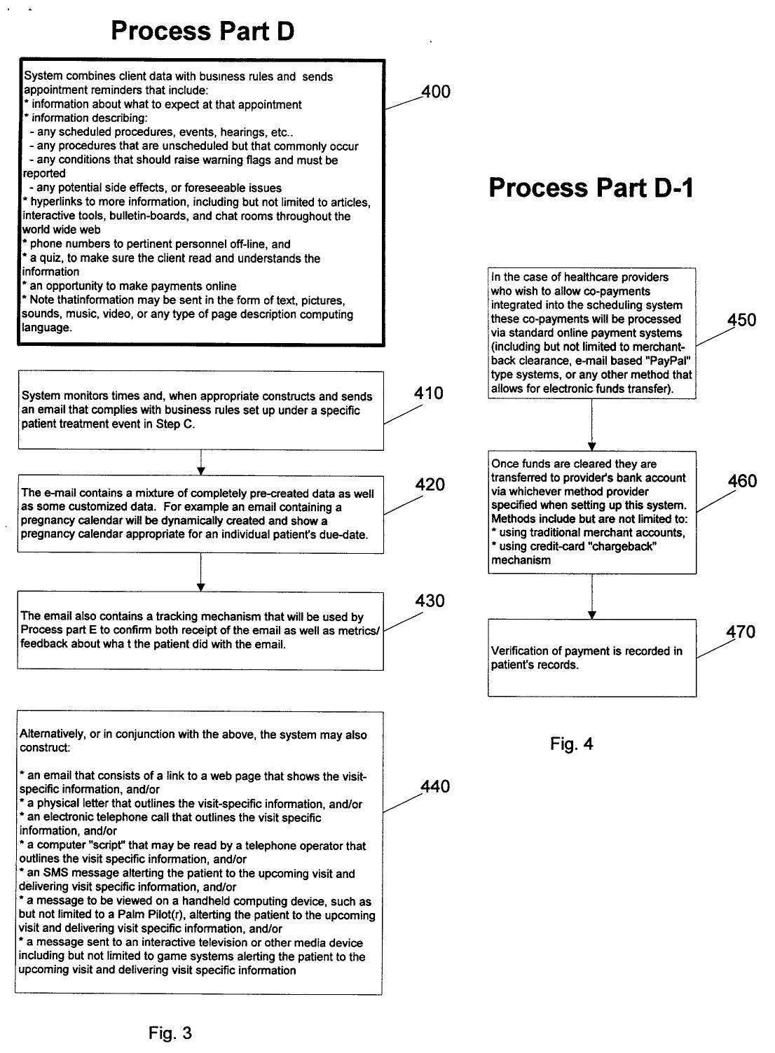

Considering step 400 further, FIG. 3 details further aspects of one embodiment of the system. At 410, the system monitors times and, when appropriate constructs and sends an email that complies with business rules set up under a specific patient treatment event in Step 300. At 420, the e-mail contains a mixture of completely pre-created data as well as some customized-data. For example an e-mail containing a pregnancy calendar will be dynamically created and show a pregnancy calendar appropriate for an individual patient's due-date. At 430, the email also contains a tracking mechanism that will be used by Process part E to confirm both receipt of the e-mail as well as metrics/feedback about what the patient did with the e-mail.

At 440, alternatively or in conjunction with the foregoing, the system may also construct: an email that consists of a link to a web page that shows the visit-specific information, a physical letter that outlines the visit-specific information, an electronic telephone call that outlines the visit specific information, a computer “script” that may be read by a telephone operator that outlines the visit specific information, an SMS message alerting the patient to the upcoming visit and delivering visit specific information, a message to be viewed on a handheld computing device, such as but not limited to a Palm Pilot(r), alerting the patient to the upcoming visit and delivering visit specific information, and/or a message sent to an interactive television or other media device including but not limited to game systems alerting the patient to the upcoming visit and delivering visit specific information.

To consider a more specific, nonlimiting example, in the case of healthcare providers who wish to allow co-payments integrated into the scheduling system, at 450 in FIG. 4, these co-payments will be processed via standard online payment systems (including but not limited to merchant-back clearance, e-mail based “PayPal” type systems, or any other method that allows for electronic funds transfer).

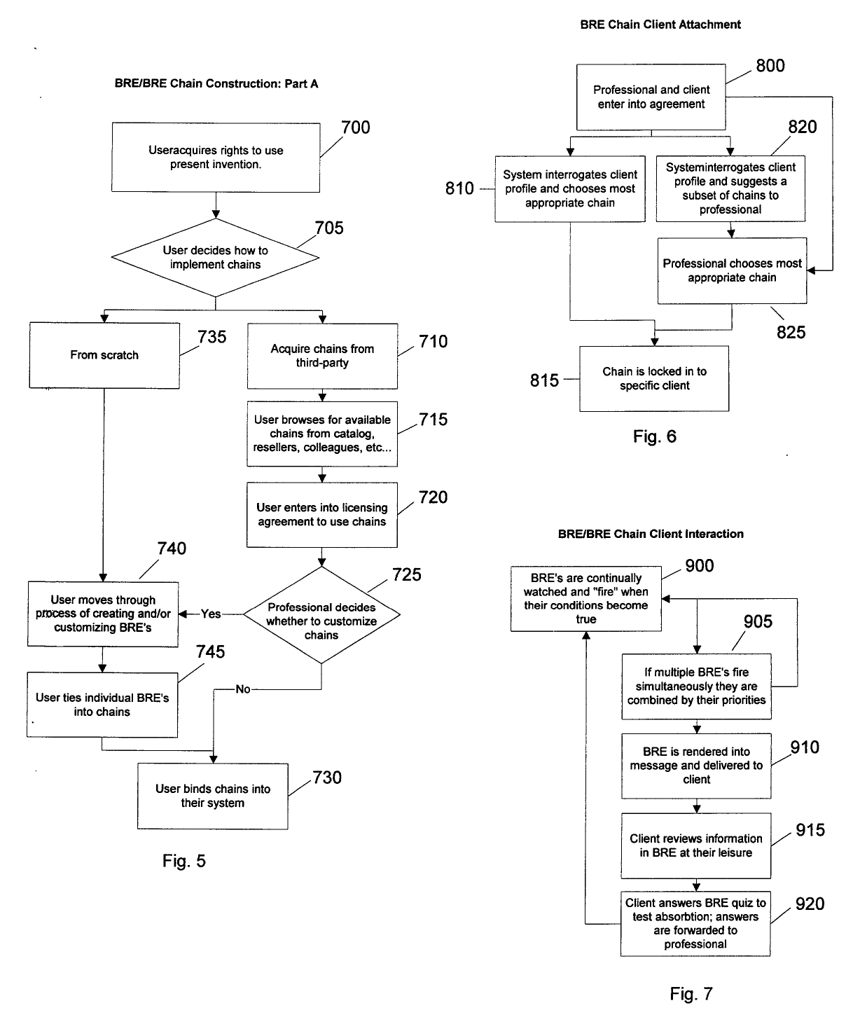

Regarding construction of BREs or BRE chains, steps 700-745 in FIG. 5 illustrates one approach to incorporating BREs or BRE chains into the system. Steps 800—825 in FIG. 6 illustrate BRE chain client attachment. Steps 900—920 in FIG. 7 illustrate BRE or BRE chain interaction with the client.

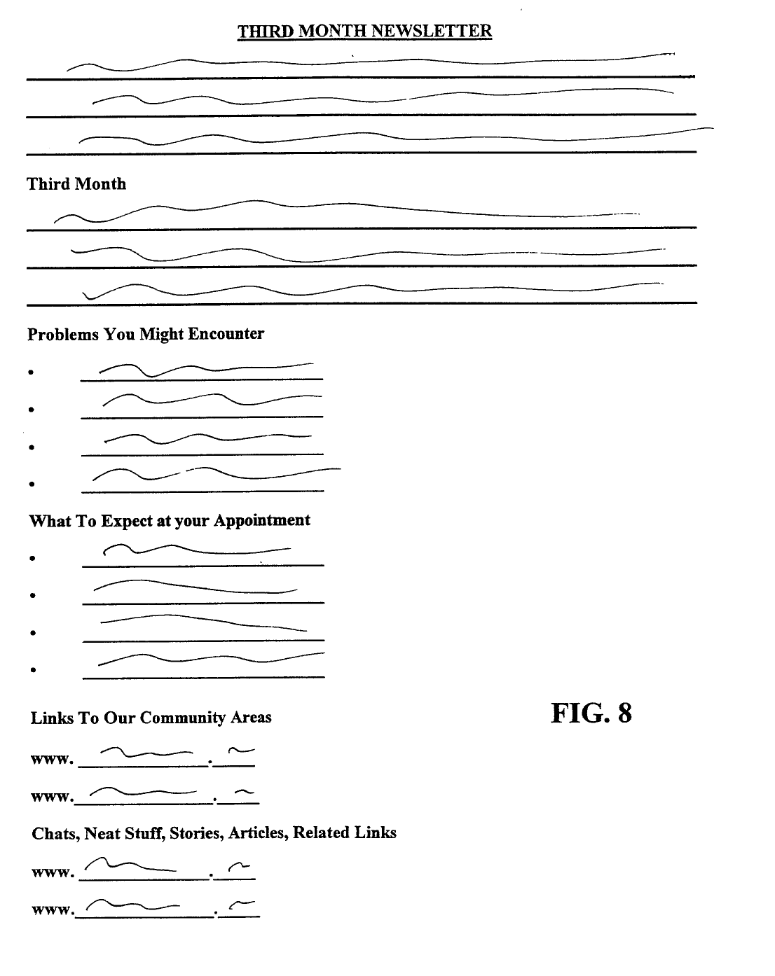

FIG. 8 illustrates one of a myriad of different possible communication formats to the client. In the specific manifestation of FIG. 8, the communication is in the form of an e-mail, which includes informative text, optional graphics, videos, audio content, links to additional resources, such as message boards, answers to frequently asked questions, and web sites. The message may also include the e-mail address of the professional or the professional's staff; to-facilitate convenient communication-between the client and professional for, as one example, asking further questions.

It is important to note that portions of this system may be used. Literally every client who becomes more educated is an incremental improvement over the current system. For example, let us first assume that in the above case of an obstetrician participation in this system changes the duration of an appointment from fifteen to ten minutes. Further assume that during these ten minutes the pregnant patient is able to ask about issues that specifically affect her. Finally, let us assume that only one in four patients actually use this system. Even under that scenario our hypothetical doctor saves a full forty minutes a day (one shorter appointment each hour for eight hours). Further, they have eight patients per day who are substantially less likely to encounter unexpected complications, are better educated about best healthcare practices, and understand and more likely to spot early signs pointing to an immediate need for some type of intervention.

Considering additional aspects of embodiments of the present invention, one embodiment of the invention includes a computer system that is capable of providing a mechanism allowing a professional to define individual Business Rule Events (“BRE”). Each BRE may include, but is not limited to text, graphics, photographs, sound (including spoken word and instrumental), video (at any resolution), links to other material, and/or links to other resources. The other resources may include, for example, telephone numbers, television programs, radio programs, and/or billing information. The billing information may include, for instance, amount due, payment history, a method to provide payment, SMS messages, quizzes, polls, surveys, and/or rules under which an event is applicable. This may include chronological sequencing with other rules, events, conditions, manual intervention by the professional, and/or output from other rules.

The priority of an individual BRE may be established when it is determined by the business rule engine to be true at the same time that other BRE's are also determined to be true.

Embodiments of the invention may include a system allowing professionals to group the individual BRE's into discrete groups. The system may allow a professional to attach one or more BRE chains to a specific client. Each chain may interact with other client information, including but not limited to a client scheduling system. This interaction may be done via a number of technologies understood in the art, including but not limited to web services, computer socket communications, http posts, and/or traditional messaging tools which may include, but are not limited to JMS, MQ Series, email.

The system may allow a professional or professionals administrative staff to manually trigger an individual BRE by setting it's conditions to true. The system may also allow a client to interact with a native scheduling system remotely, allowing rescheduling, schedule inspection, and extending the ability to add a new appointment remotely without intervention from the core staff. The system may combine the client information with the BRE data to generate a human readable communication, in any of the myriad formats listed above.

The system may send that communication, at an appropriate chronological time, to the client via any of a wide variety of known communication methods, such as email, including rich email, including multi-media components, video email, text email, and email in a format not yet invented. Alternatively, the system may communicate via traditional phone, via a computer rendered voice, an operator voice read from a generated script, personalized radio service, and/or a personalized information service broadcast from a central point. Nonlimiting examples of communication via a personalized information service may include communication via satellites, Wi-Fi clouds, mobile phone, via SMS message, other pager method, pager, and/or a portable digital assistant (PDA). The PDA may include but is not limited to handheld devices sold by Palm, portable devices based on Microsoft's Windows operating system, or Linux, or any other operating system. Communication may also be by a portable tablet general purpose computing device, a portable e-paper device, and/or interactive television. The interactive television may also optionally include a personal television recorder, that may be locally cached and processed, remotely cached and processed, and/or transmitted by another broadcast/hybrid television device.

The system may also communicate via interactive appliances that may be embedded with component scheduling systems, including but not limited to devices embedded in kitchen appliances (refrigerators, ovens, etc.), automobiles, clothing, and/or a wide range of other appliances. The system may also be adapted to communicate via other tools that are either embedded or that stand alone in other software applications.

The client of the professional will typically communicate back to the professional that sent the communication. For example, the method may include communicating to the professional that the rendered message was received, if the client's messaging system supports receipts. The return communication may also include the results of quizzes, polls, surveys, and/or payment information back to the sender.

Another embodiment of the invention provides a method for creating a business rule event. The BRE may include selecting the information contained in the event, and selecting the trigger of the event, which may be but is not limited to one or more of the following: time, an event, a series of events, a condition being met, a series of conditions being met, manual intervention from the professional, manual intervention from the intended recipient, manual intervention from a caregiver of the intended recipient, output from a computerized scheduling system, output from a manual scheduling system, and/or the triggering of a different series of business rule events.

The method may also include selecting the action that the trigger should start, including but not limited to sending an electronic message, including but not limited to email messages, SMS messages, pages, telephone calls (both computer driven or read by an operator via a generated script), messages to interactive entertainment systems, messages to computers and/or computer programs, messages to embedded scheduling systems. The method might also or alternatively include sending a tangible media message (such as a letter, package and/or a fax), starting another business rule, triggering a web service or triggering another computer program

Other embodiments of the invention may include a method for chaining and bundling business rule events, such as sequentially chaining together business rule events, chronologically chaining together business rule events, and/or conditionally chaining business rule events. Another aspect of the invention may include a method for chaining together business rule chains into broader chains, a method for binding a specific client to a specific chain, a method for overriding an individual business rule event when a specific chain is bound to a specific client, and/or a method for overriding an individual chain when a specific chain is bound to a specific client.

While the specification describes particular embodiments of the present invention, those of ordinary skill can devise variations of the present invention without departing from the inventive concept.

We claim:

1. A method for interaction between a professional and a client of the professional comprising the steps of:
establishing individual Business Rule Events;
entering client information into a computer database;
transmitting customized content to the client based upon information about the client and the Business Rule Events; and
receiving return communication from the client.

2. A method as defined in claim 1, wherein the Business Rule Events comprise at least one of the group comprising text, graphics, photographs, sound, video, links to other material, telephone numbers, television programs, radio programs, and billing information.

3. A method as defined in claim 2, wherein at least one Business Rule Event relates to billing, and the step of communicating with the client comprises communicating at least one of an amount due, payment history, a method to provide payment, an, SMS message, a quiz, a poll, and a survey.

4. A method as defined in claim 1, wherein at least some of the Business Rule Events are chronologically sequenced with other rules.

5. A method as defined in claim 1, wherein at least some of the Business Rule Events are sequenced with other events.

6. A method as defined in claim 1, wherein at least some of the Business Rule Events are sequenced with other conditions.

7. A method as defined in claim 1, wherein the method further comprises manual intervention by the professional prior to communicating with the client.

8. A method as defined in claim 1, wherein at least one Business Rule, Event is triggered by output from another Business Rule Event.

9. A method as defined in claim 1, wherein there are a plurality of Business Rule Events, and the method further comprises establishing a priority of individual Business Rule Events when a business rule engine determines a Business Rule Event when at least one other BRE is also determined to be true.

10. A method as defined in claim 1, wherein the method further comprises grouping the individual Business Rule Events into discrete Business Rule Event chains.

11. A method as defined in claim 10, further comprising the step of attaching one or more BRE chains to a specific client.

12. A method as defined in claim 10, wherein the method includes transmitting client appointment scheduling information to the client.

13. A method as defined in claim 12, wherein the method includes the client transmitting information back to the professional to confirm an appointment schedule.

14. A method as defined in claim 12, wherein the method includes the client transmitting information back to the professional to reschedule an appointment.

15. A method as defined in claim 1, wherein the step of communicating with the client comprises communicating via at least one of web services, computer socket communications, http posts, JMS, MQ Series, and email.

16. A method as defined in claim 1, wherein the method further comprises the step of manually intervening to manually trigger an individual BRE by setting it's conditions to true.

17. A method as defined in claim 1, wherein the method further comprises receiving scheduling information from a client from a remote location.

18. A method as defined in claim 1, wherein the method further comprises providing the client with appointment scheduling information, receiving rescheduling information from the client, and rescheduling a client appointment.

19. A system for communicating between a professional and a client of the professional, comprising:
means for communicating with a client; and
means to transmit client information based upon stored client data and the satisfaction of at least one rule.

20. A system as defined in claim 19, wherein the system further comprises means for verifying that a client has understood information that a professional has transmitted to the client.

21. A system as defined in claim 19, wherein the system further comprises means for rescheduling a client appointment from a remote location.
